(19) United States
(12) Patent Application Publication
(10) Pub. No.: US 2019/0077998 A1
(43) Pub. Date: Mar. 14, 2019

(54) SELF-ADHESIVE ARTICLE AND USE THEREOF FOR BONDING ON COATED WOODCHIP WALLPAPER

(71) Applicant: TESA SE

(72) Inventors: Thilo DOLLASE, Hamburg (DE); Julia GARBERS, Hamburg (DE); Tanja ALTENWEGNER, Hamburg (DE)

(73) Assignee: TESA SE, Norderstedt, OT (DE)

(21) Appl. No.: 15/767,239

(22) PCT Filed: Oct. 13, 2016
(86) PCT No.: PCT/EP2016/074551

§ 371 Date: Apr. 10, 2018

(30) Foreign Application Priority Data
Oct. 15, 2015 (DE) 10 2015 220 072.8

(51) Int. Cl. C09J 7/38; C09J 7/26; C09J 153/02; B32B 5/18; B32B 7/12; B32B 27/30; B32B 27/06

(52) U.S. Cl. CPC C09J 7/385; C09J 7/26; C09J 153/02; B32B 5/18; B32B 7/12; B32B 27/302; B32B 2405/00; C09J 2201/134; C09J 2201/618; C09J 2400/243; C09J 2453/00; B32B 2255/102; B32B 2307/72; B32B 27/065

(57) ABSTRACT

A self-adhesive article comprising (i) at least one carrier material which comprises at least one foamed layer having a first surface A and a second surface B, the at least one foamed layer of the carrier material having a thickness of at least 500 μm and at most 1800 μm, a tensile strength in detachment direction of at least 500 kPa, a tensile elongation in detachment direction of at least 300% and a compressive hardness of at least 50 kPa, (ii) a layer HKA of pressure-sensitive adhesive (PSA) assigned to the surface (A), (iii) a PSA layer HKB assigned to the surface (B) and (iv) optionally further layers; the PSA layers HKA and HKB may be two PSA layer combinations.

This is a 371 of PCT/EP2016/074551 filed 13 Oct. 2016, which claims foreign priority benefit under 35 U.S.C. 119 of German Patent Application 10 2015 220 072.8 filed Oct. 15, 2015, the entire contents of which are incorporated herein by reference.

The present invention relates to self-adhesive articles comprising
(i) at least one carrier material which comprises at least one foamed layer having
   a first surface A and a second surface B,

wherein the at least one foamed layer of the carrier material has
a thickness of at least 500 μm, preferably at least 850 μm, and at most 1800 μm, preferably at most 1500 μm,
a density of at least 30 kg/m³, preferably at least 45 kg/m³, and at most 120 kg/m³, preferably at most 100 kg/m³,
a tensile strength in detachment direction of at least 500 kPa, preferably at least 700 kPa,
a tensile elongation in detachment direction of at least 300%, preferably at least 500%, and
a compression stress of at least 50 kPa, preferably at least 70 kPa, and at most 300 kPa, preferably at most 200 kPa,
(ii) a pressure-sensitive adhesive layer HKA which is assigned to the surface A,
(iii) a pressure-sensitive adhesive layer HKB which is assigned to the surface B,
(iv) optionally one or more further layers,

and also to the use of such self-adhesive articles.

### BACKGROUND OF THE INVENTION

Self-adhesive products detachable without residue from a bond substrate by extensive stretching are known. They are available commercially, for example, as tesa Powerstrips® or 3M Command™.

The manifold applications of adhesive strips comprising such adhesives include bonds on walls, and specifically not just on smooth, planar substrates but also, specifically, on any rough surfaces as well, such as plaster, wood, woodchip wallpaper, especially coated woodchip wallpapers, other textured wallpapers, panels or wall boards. Here as well there is a desire to affix articles, including those of high weight, without damage to the substrate (the wall). In adhesive bonding, for example, on coated woodchip wallpaper, in comparison with many other substrates, however, there are in particular three special challenges: (a) woodchip wallpaper is a non-smooth bond substrate; (b) the surface of the woodchip wallpaper is customarily provided with a paint coating which, as a result of binders and/or additives, may have a low surface energy; (c) in particular, woodchip wallpaper represents a relatively easily splittable bond substrate, which is not to be damaged during redetachment. Depending on the nature of the paint coating, the surface properties may vary sharply. Another aspect is the moisture content of the coated woodchip wallpaper, which is dependent on the time of day/season and on the geographic region and which, correspondingly, may also be subject to temporary fluctuations. For other substrates among those exemplified above, some or all of these challenges are similarly valid. For such challenges, suitable adhesives are sought. Sought also are adhesive strips featuring adhesives with high bonding and holding performance that are detachable from coated plaster or other rough surfaces without residue and as far as possible without destruction, by extensive stretching.

Adhesives for this purpose may be formulated advantageously on the basis of styrene block copolymers and tackifier resins.

Pressure-sensitive adhesive strips with high elastic or plastic extensibility, which can be redetached without residue or destruction by extensive stretching in the bond plane, are known from, for example, U.S. Pat. No. 4,024,312 A, DE 33 31 016 C2, WO 92/01132 A1, WO 92/11333 A1, DE 42 22 849 A1, WO 95/06691 A1, DE 195 31 696 A1, DE 197 08 366 A1, DE 196 49 727 A1, DE 196 49 728 A1, DE 196 49 729 A1, DE 197 08 364 A1, DE 197 20 145 A1, DE 198 20 854 A1 and DE 100 03 318 A1, and are also referred to below as strippable pressure-sensitive adhesive strips or simply as (adhesive) strips. Formulations which can be used with particular advantage for these adhesive products are those containing styrene block copolymer.

The application of bonding adhesive strips to woodchip wallpaper has in principle likewise already been described, with typical applications being within private households and in offices.

DE 10 2004 030 252 A1 describes a hook system for fastening to a rough substrate, that allows the adhesive strip to be detached without residue from the sensitive surface. Specific embodiments of the adhesive in the adhesive strip redetachable by extensive stretching are not provided.

EP 845 513, EP 845 514, and EP 845 515 describe requirements associated with bonding to rough substrates, and observe that high bond strengths are generally achievable on smooth and solid substrates with the self-adhesive tapes identified beforehand. On rough substrates, the bond strength is, for numerous applications, inadequate, especially for products of low thickness, but even for self-adhesive tapes of relatively high layer thickness. An assumed cause of the inadequate bond strength is an insufficient bond area, caused by inadequate conformability of the adhesive tapes to rough and irregular surfaces.

As a solution, EP 845 513 A2 proposes the use of specific foam carriers in the adhesive products. These are ethylene (co)polymers, ethylene-vinyl acetate copolymers, polyvinyl acetates, polypropylenes, EPDM, thermoplastic elastomers based on styrene block copolymers, polyurethanes based on aromatic and aliphatic diisocyanates, PVC, polychloroprenes, natural rubber or acrylate copolymers. The thicknesses of the foams used are between 175 μm and 30 mm. Volume densities are 20 to 500 kg/m³. The elongation at break of the foams used is less than the elongation at break of the pressure-sensitive adhesive which determines the tensile strength. Pressure-sensitive adhesives (PSAs) used preferentially are those based on block copolymers containing polymer blocks formed from vinylaromatics, preferably styrene, and blocks formed by polymerization of 1,3-dienes, preferably butadiene and isoprene. The examples consistently employ combinations with an isoprene-containing (block co)polymer. It is true that applications for non-destructive redetachment on woodchip wallpaper are identified. Holding power data, however, are not reported.

As a solution, EP 845 514 A2 proposes the use of further specific foam carriers in the adhesive products. The foam carriers are pre-damaged in a particular way, so as to reduce the detachment force (stripping force). The basic materials for the foam carriers are ethylene (co)polymers, ethylene-vinyl acetate copolymers, polyvinyl acetates, polypropylenes, EPDM, thermoplastic elastomers based on styrene block copolymers, polyurethanes based on aromatic and aliphatic diisocyanates, PVC, polychloroprenes, natural rubber or acrylate copolymers. The thicknesses of the foams used are between 175 μm and 30 mm. Volume densities are 20 to 500 kg/m³. To adjust the detachment forces, the foam carriers are deliberately damaged, by being perforated, cut or punched, for example. PSAs employed are preferably those based on block copolymers comprising polymer blocks formed by vinylaromatics, preferably styrene, and blocks formed by polymerization of 1,3-dienes, preferably butadiene and isoprene. The examples employ a combination of a polystyrene-polyisoprene block copolymer with a polystyrene-polybutadiene block copolymer.

As a solution, EP 845 515 A2 proposes the use of further specific foam carriers in the adhesive products. The foam carriers have a particularly low modulus of elasticity. Base materials specified for the foam carriers are ethylene-vinyl acetate copolymers and also mixtures of ethylene-vinyl acetate copolymers and/or polyvinyl acetates with polyethylenes. Further suitable polymers are polyvinyl acetates, EPDM, thermoplastic elastomers based on styrene block copolymers, polyurethanes based on aromatic and aliphatic diisocyanates, PVC, polychloroprenes, and natural rubber. The thicknesses of the foams used are between 150 μm and 600 μm. Volume densities are 40 to 300 kg/m³. The modulus of elasticity is at most 16 MPa. PSAs employed are preferably those based on block copolymers comprising polymer blocks formed of vinylaromatics, preferably styrene, and blocks formed by polymerization of 1,3-dienes, preferably butadiene and isoprene. The examples employ a combination of a polystyrene-polyisoprene block copolymer with a polystyrene-polybutadiene block copolymer.

U.S. Pat. No. 6,231,962 B1 and U.S. Pat. No. 6,403,206 B1 likewise described double-sided adhesive strips with a foam carrier. Bond substrates specified for adhesive bonding applications are sensitive, easily splittable substrates such as painted wall boards, but not particularly rough substrates such as coated woodchip wallpaper. Adhesives which can be used include styrene block copolymer-based formulations. Specific example formulations typically utilize mineral oil as plasticizer. In the context of application to woodchip wallpaper, however, this is a disadvantage, since the substrate may absorb grease, a phenomenon which may remain visible following removal of the adhesive strip. The specifications teach foam carriers having a maximum elongation of 50% to 1200%, a density of between 32 kg/m³ and 481 kg/m³, and a thickness of between 760 μm and 25 mm. The foam carrier may also comprise multilayer carriers. These have a modulus of elasticity of between preferably about 7 MPa and about 16.5 MPa. The foam may be based on materials such as polyethylenes, polypropylenes, polybutylenes, PVC, polyvinyl acetates, EVA, ABS, polyacrylates, or polyurethanes.

EP 1 988 141 A1 proposes adhesives which in relation to the total resin amount contain at least 40% of a plasticizing resin. Stated applications include the bonding of lightweight (papers) to moderately heavy objects to woodchip wallpaper. An objective of such formulations is not to have high holding power, but rather the possibility of parting the bond, even from woodchip wallpaper, by extensive stretching or peeling. The adhesive products may include a stretchable intermediate carrier, which may also be in foamed form. The foam carriers are not further specified.

U.S. Pat. No. 7,276,272 B2 describes double-sided adhesive strips which can be redetached even from sensitive substrates such as plaster, paint, or wallpaper. No bond substrates with particularly pronounced roughness are specified. Specific adhesives and foam carriers are not explicitly stated.

US 2008/0135159 A1 discloses further adhesive strips for textured surfaces. They comprise foam carriers having a thickness of between about 200 μm and about 550 μm, a density between about 64 kg/m³ and about 240 kg/m³, and a maximum elongation of between 50% and 1200%. Adhesive bonding to woodchip wallpaper of particularly pronounced roughness is not a topic. Instead, a solution is proposed for bonding to plasticizer-containing textured surfaces such as “textured vinyl wallpaper”.

There continues to be a need for self-adhesive strips which are redetachable by extensive stretching and which are especially suitable for rough substrates, particularly on coated woodchip wallpaper, in that they offer a high holding power and allow redetachment to take place without destruction of the substrate.

The desire is therefore for improved self-adhesive products for adhesive bonding on splittable and/or rough coated substrates, with high bonding and holding performance, that are redetachable without residue by extensive stretching, without damaging the substrate.

### SUMMARY OF THE INVENTION

The object is achieved by means of self-adhesive articles of the type specified at the outset, for which
the pressure-sensitive adhesive layers HKA and HKB are selected from a group of pressure-sensitive adhesive layer combinations consisting of pressure-sensitive adhesive layer combination 1 and pressure-sensitive adhesive layer combination 2, wherein, for pressure sensitive adhesive layer combination 1, pressure sensitive adhesive layer HKA is a pressure sensitive adhesive layer HKA1 which comprises
(a) at least one elastomer component of the type of polybutadiene-polyvinylaromatic block copolymer having a fraction in relation to the total adhesive of 42 wt % to 55 wt % and a diblock fraction in relation to the total block copolymer content of 32 wt % to 55 wt %, preferably to 50 wt %,
(b) at least one tackifier resin which is a hydrocarbon resin having a DACP of at least +5° C. and at most +50° C. and an MMAP of at least +50° C. and at most +85° C.,
(c) optionally at least one plasticizing resin having a fraction of 0 wt % to 15 wt %, based on the total adhesive,
(d) optionally further additives
and wherein, for pressure-sensitive adhesive layer combination 1, pressure-sensitive adhesive layer HKB is a pressure-sensitive adhesive layer HKB1 which has a tensile strength of at least 9 MPa, preferably of at least 11 MPa, and wherein, for pressure-sensitive adhesive layer combination 2, pressure-sensitive adhesive layer HKA is a pressure-sensitive adhesive layer HKA2 and pressure-sensitive adhesive layer HKB is a pressure-sensitive adhesive layer HKB2, which each, but independently of one another, comprise
(e) at least one elastomer component of the type of a polybutadiene-polyvinylaromatic block copolymer having a fraction in relation to the total adhesive of 38 wt % to 48 wt % and a diblock fraction in relation to the total block copolymer content of 10 wt % to 30 wt %,
(f) at least one tackifier resin which is a hydrocarbon resin having a DACP of at least +5° C. and at most +50° C. and an MMAP of at least +50° C. and at most +85° C.,
(g) at least one plasticizing resin having a fraction of 2 wt % to 15 wt %, based on the total adhesive,
(h) optionally further additives.

### DETAILED DESCRIPTION

### BRIEF DESCRIPTION OF THE DRAWING

FIG. 1 illustrates the determination of glass transition temperature by means of dynamic scanning calorimetry (DSC).

“Consist of” or “consisting of” in the sense of the present invention means that a formulation or adhesive contains only the compounds stated and that, over and above these compounds, there are no further ingredients present.

The phrasing whereby the pressure-sensitive adhesive layer HKA is assigned to the surface A and, respectively, the pressure-sensitive adhesive layer HKB is assigned to the surface B means that HKA is applied on the surface A and, respectively, that HKB is applied on the surface B, with the PSA layer preferably mounted directly on the respective surface, though with the possibility also of the presence of further layers between the surface and the PSA layer.

A first subject of the invention relates to a self-adhesive article comprising

(i) at least one carrier material which comprises at least one foamed layer having a first surface A and a second surface B,

wherein the at least one foamed layer of the carrier material has
a thickness of at least 500 μm, preferably at least 850 μm, and at most 1800 μm, preferably at most 1500 μm,
a density of at least 30 kg/m³, preferably at least 45 kg/m³, and at most 120 kg/m³, preferably at most 100 kg/m³,
a tensile strength in detachment direction of at least 500 kPa, preferably at least 700 kPa,
a tensile elongation in detachment direction of at least 300%, preferably at least 500%, and
a compression stress of at least 50 kPa, preferably at least 70 kPa, and at most 300 kPa, preferably at most 200 kPa,

(ii) a pressure-sensitive adhesive layer HKA which is assigned to the surface A,

(iii) a pressure-sensitive adhesive layer HKB which is assigned to the surface B,

(iv) optionally one or more further layers,

wherein the self-adhesive article is characterized in that the pressure-sensitive adhesive layers HKA and HKB form a pressure-sensitive adhesive layer combination 1,

wherein, for pressure-sensitive adhesive layer combination 1, pressure-sensitive adhesive layer HKA is a pressure-sensitive adhesive layer HKA1 which comprises

i. at least one elastomer component of the type of polybutadiene-polyvinylaromatic block copolymer having a fraction in relation to the total adhesive of 42 wt % to 55 wt % and a diblock fraction in relation to the total block copolymer content of 32 wt % to 55 wt %, preferably to 50 wt %,

ii. at least one tackifier resin which is a hydrocarbon resin having a DACP of at least +5° C. and at most +50° C. and an MMAP of at least +50° C. and at most +85° C.,

iii. optionally at least one plasticizing resin having a fraction of 0 wt % to 15 wt %, based on the total adhesive,

iv. optionally further additives

and wherein pressure-sensitive adhesive layer HKB is a pressure-sensitive adhesive layer HKB1 which has

a tensile strength of at least 9 MPa, preferably of at least 11 MPa.

A second subject of the invention relates to a self-adhesive article comprising

(i) at least one carrier material which comprises at least one foamed layer having a first surface A and a second surface B,

wherein the at least one foamed layer of the carrier material has
a thickness of at least 500 μm, preferably at least 850 μm, and at most 1800 μm, preferably at most 1500 μm,
a density of at least 30 kg/m³, preferably at least 45 kg/m³, and at most 120 kg/m³, preferably at most 100 kg/m³,
a tensile strength in detachment direction of at least 500 kPa, preferably at least 700 kPa,
a tensile elongation in detachment direction of at least 300%, preferably at least 500%, and
a compression stress of at least 50 kPa, preferably at least 70 kPa, and at most 300 kPa, preferably at most 200 kPa,

(ii) a pressure-sensitive adhesive layer HKA which is assigned to the surface A,

(iii) a pressure-sensitive adhesive layer HKB which is assigned to the surface B,

(iv) optionally one or more further layers,

wherein the self-adhesive article is characterized in that the pressure-sensitive adhesive layers HKA and HKB form a pressure-sensitive adhesive layer combination 2,

wherein, for pressure-sensitive adhesive layer combination 2, pressure-sensitive adhesive layer HKA is a pressure-sensitive adhesive layer HKA2 and pressure-sensitive adhesive layer HKB is a pressure-sensitive adhesive layer HKB2, which each, but independently of one another, comprise

v. at least one elastomer component of the type of a butadiene block copolymer having a fraction in relation to the total adhesive of 38 wt % to 48 wt % and a diblock fraction in relation to the total block copolymer content of 10 wt % to 30 wt %,

vi. at least one tackifier resin which is a hydrocarbon resin having a DACP of at least +5° C. and at most +50° C. and an MMAP of at least +50° C. and at most +85° C.,

vii. at least one plasticizing resin having a fraction of 2 wt % to 15 wt %, based on the total adhesive,

viii. optionally further additives.

Pressure-Sensitive Adhesive HKA1

In the bonded state, pressure-sensitive adhesive (PSA) HKA1 comes into contact with the rough surface (particularly woodchip wallpaper). It is especially suitable for compensating roughnesses on the part of the bond substrate.

(a) Elastomer (Block Copolymer)

Employed as elastomer component (block copolymer component), preferably to an extent of at least 90 wt % (based on the total block copolymer content), is a polybutadiene-polyvinylaromatic block copolymer or a mixture of different polybutadiene-polyvinylaromatic block copolymers. This polybutadiene-polyvinylaromatic block copolymer and, respectively, these polybutadiene-polyvinylaromatic block copolymers are polymers comprising polymer blocks predominantly formed from vinylaromatics (A blocks), preferably styrene, and blocks predominantly formed by polymerization of 1,3-butadiene (B blocks). Polybutadiene block copolymers (SBS) are preferred for the purposes of this invention on the basis of their greater stability with respect to external influences such as ozone, for example, by comparison with polyisoprene block copolymers (SIS). SIS-containing formulations can customarily not be matched 1:1 with SBS-containing and SIS-free formulations if a comparable profile of mechanical properties is to be achieved. If the aim is to do without SIS in the formulation and to work instead with SBS, the SBS-containing formulations must be specially adapted in order to meet the stipulated profile of properties. These differences may be explained at least in part by the softness of SIS and SBS (indicated by the Shore A hardness). The Shore A hardness is typically lower for SIS than for SBS systems.

The elastomer mixture comprises at least one polybutadiene-polyvinylaromatic block copolymer consisting of an A block and a B block, known as the diblock copolymer. Diblock copolymers contribute to tack and flow-on of the adhesive. The elastomer mixture further comprises a triblock copolymer or a higher multiblock copolymer having at least two A blocks and at least one B block. As a triblock copolymer, this copolymer may have a linear A-B-A structure. Likewise employable are block copolymers with a radial architecture, and also star-shaped and linear multiblock copolymers. Triblock and multiblock copolymers contribute to cohesion and tensile strength of the adhesive. A plurality of different diblock copolymers may be used. A plurality of triblock and/or multiblock copolymers may be used. The total block copolymer content of the adhesive is at least 42 wt % and at most 55 wt %. Significantly lower fractions of elastomer result in inadequate cohesion, which is manifested in reduced holding power and/or reduced tear resistance during the detachment operation carried out with extensive stretching. Significantly higher fractions of elastomer result in a drop in bond strength particularly on nonpolar substrates such as, for example, nonpolar paint. The fraction of diblock copolymers, based on the total block copolymer content, in the adhesive formulation is at least 32 wt % and at most 55 wt %, preferably at most 50 wt %. Significantly higher diblock fractions result in inadequate cohesion, which is manifested in reduced holding power and/or reduced tear resistance during the detachment operation carried out with extensive stretching. Significantly lower diblock fractions result in a drop in bond strength particularly on nonpolar substrates such as, for example, nonpolar paint. Correspondingly, the fraction of triblock or higher multiblock copolymer is from 45 wt % to 68 wt %, preferably 50 wt % to 68 wt %, in relation to the total block copolymer content. Of the triblock or higher multiblock copolymers, the triblock copolymers are particularly preferred.

The weight-average molar mass (measured according to Test I) of the block copolymers is between 50 000 g/mol and 500 000 g/mol, preferably between 75 000 g/mol and 200 000 g/mol. The fraction of vinylaromatic block in the block copolymers may be different from one variety of block copolymer to another in the formulation, but is typically at least 20 wt %, preferably at least 25 wt %, and at most 40 wt %, preferably at most 35 wt %. Too low a polyvinylaromatic fraction results in insufficient physical crosslinking, which is provided by microphase separation in the polybutadiene-polyvinylaromatic block copolymers. The physical crosslinking is important for the holding power and the tear resistance. If the polyvinylaromatic fraction is too high, in contrast, the adhesive loses tack.

The A blocks in the block copolymers of the PSAs are preferably polystyrene end blocks. Instead of the preferred polystyrene blocks, other vinylaromatics which can be utilized are polymer blocks based on other aromatic-containing homopolymers and copolymers (preferably C8 to C12 aromatics) having glass transition temperatures of greater than 75° C., such as α-methylstyrene-containing aromatic blocks, for example. Furthermore, identical or different A blocks may also be present. Glass transition temperatures are determined according to Test II.

A blocks in the context of this invention are also referred to as “hard blocks”. B blocks, correspondingly, are also called “soft blocks” or “elastomer blocks”. This reflects the inventive selection of the blocks in accordance with their glass transition temperatures (for A blocks at least 40° C., more particularly at least 60° C., and for B blocks at most −50° C., more particularly at most −80° C.). These figures relate to the pure, unblended block copolymers.

The polybutadiene block copolymers resulting from the A and B blocks may comprise identical or different B blocks in terms more specifically of microstructure (relative ratio of the types of monomer linkage possible for polybutadiene, i.e., 1,4-cis, 1,4-trans, and 1,2-vinyl: the 1,4 fraction (cis +trans) is preferably >75%, very preferably >85%, based on the polybutadiene blocks, and the 1,4-cis fraction is preferably >40%, based on the polybutadiene blocks) and/or of chain length. A high fraction of 1,4 linkage and especially 1,4-cis linkage of the monomer units in the polybutadiene blocks leads to advantageous tension/elongation characteristics, resulting in sufficient stretchability, which is important particularly for the residue-free redetachment by stretching. The 1,2-vinyl units may be in hydrogenated form. Advantageously, the 1,4 units are substantially unhydrogenated.

(b) Tackifier Resin

Tackifier resins are special compounds having a low molar mass by comparison with the elastomers, their molecular weight (Test I) M_{w} typically being <5000 g/mol. The molecular weight M_{w} is typically from 500 to 5000 g/mol, preferably from 500 to 2000 g/mol. The at least one tackifier resin has a DACP (according to Test III) of at least about +5° C. and at most about +50° C., preferably at most about +45° C., and also an MMAP (according to Test IV) of at least about +50° C. and at most about +85° C., preferably at most of about +80° C. For tackifier resins selected appropriately, compatibility with the polybutadiene blocks and incompatibility with polyvinylaromatic blocks is anticipated to an extent favorable for the purposes of this information. The tackifier resin has a resin softening temperature (according to Test V) of at least about 90° C., preferably of at least about 110° C., and at most +140° C., preferably of at most +120° C. The at least one tackifier resin used advantageously comprises a hydrocarbon resin.

Polarity which is too high (DACP too low) leads to incipient incompatibility with the vinylaromatic blocks, possibly resulting in a reduction in cohesion and hence in the tensile strength. Polarity which is too low (DACP too high) leads to incompatibility on the part of the tackifier resin with the soft block and hence to a loss of pressure-sensitive adhesiveness.

Aromaticity which is too high (MMAP too low) leads to incipient incompatibility with the vinylaromatic blocks, possibly leading to reduction in cohesion and hence in the tensile strength. Aromaticity which is too low (MMAP too high) leads to incompatibility on the part of the tackifier resin with the soft block and hence to a loss of pressure-sensitive adhesiveness.

The resins are selected preferably from the resin classes of the (partially) hydrogenated aromatically modified C5 resins, the polyterpene resins (prepared from α-pinene, β-pinene, δ-limonene, or mixtures of these starting materials), the partially hydrogenated C9 resins, the (partially) hydrogenated aromatically modified α-pinene resins, the (partially) hydrogenated aromatically modified β-pinene resins, the (partially) hydrogenated aromatically modified δ-limonene resins, and the (partially) hydrogenated aromatically modified dipentene resins. In the context of the aromatic modification, preference is given to styrene. Polyterpene resins are especially preferred.

(c) Optional Plasticizing Resins

The optionally employable plasticizing resin serves for final fine-tuning of the cohesion/adhesion balance. The resin in question very preferably comprises a plasticizing resin or plasticizing resin mixture with a melt viscosity of at least 25 Pa*s, preferably of at least 50 Pa*s, at 25° C. and 1 Hz, and with a softening temperature of <25° C. The melt viscosity is determined according to Test VI. The plasticizing resin may be a rosin-based plasticizing resin or very preferably a hydrocarbon-based plasticizing resin. The plasticizing resin or plasticizing resin mixture is employed, in relation to the total adhesive formulation, with a fraction of 0 wt % to 15 wt %, preferably of at least 5 wt % and at most 12 wt %, based on the total adhesive composition. Too high a fraction of plasticizing resin results in a reduction in cohesion, which is manifested in the holding power and in the tensile strength.

Customary low-viscosity plasticizers such as mineral oils are disadvantageous for the purposes of this invention. Their fraction in the total formula is preferably not more than 1 wt %, and very preferably no such plasticizers at all are used. A disadvantage of low-viscosity plasticizers is the risk of grease saturation on absorbent bond substrates such as woodchip wallpaper. When the adhesive strip is redetached, an unwanted visible sign is left at the bond site.

(d) Optional Further Additives

The adhesive may be admixed with further additives, especially inhibitors. These include aging inhibitors of primary and secondary types, light stabilizers and UV protectants, and also flame retardants, and additionally fillers, dyes, and pigments. The adhesive may accordingly be given any desired color or may be white, gray, or black.

Typical usage amounts for an additive are up to 1 wt %, based on the total adhesive composition. Particularly advantageous are aging inhibitors which do not leave colored residues on bond substrates (in this regard see the prior art of EP 1 341 862 B1).

Fillers can be used in higher quantities, typically in a fraction of up to 5 wt %, based on the total adhesive composition.

Additives which can typically be utilized are as follows:
primary antioxidants such as sterically hindered phenols, for example
secondary antioxidants, such as phosphites or thioethers, for example
processing stabilizers such as C-radical scavengers, for example
flame retardants
light stabilizers such as UV absorbers or sterically hindered amines, for example
dyes and/or pigments (e.g., carbon black)
processing assistants
(nano)fillers such as, for example, silicon dioxide, aluminum oxide, titanium dioxide, or phyllosilicates, and color pigments and dyes (for transparent embodiments which nevertheless have deliberate coloring), and also optical brighteners
endblock reinforcer resins, and
optionally further polymers, preferably elastomeric in nature; elastomers utilizable accordingly include, among others, those based on pure hydrocarbons, as for example polybutadiene, elastomers with substantial chemical saturation such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, and allyl or vinyl ether-containing polyolefins.

The selection of additives is preferably confined to those specified above.

Pressure-Sensitive Adhesive HKB1

Pressure-sensitive adhesive (PSA) HKB1 endows the overall product with tensile strength, by virtue of its mechanical properties. As a single layer, it has a tensile strength of at least 9 MPa, preferably of at least 11 MPa. This adhesive imparts tensile strength to multilayer constructions which include an adhesive layer of the kind HKA1. In a bond between two substrates, HKB1 comes into contact with the second substrate, which customarily is not distinguished by particularly pronounced roughness/splittability. This second substrate may in particular be a mounting plate of a hook body.

(a) Elastomer (Block Copolymer)

Employed preferably as elastomer component (block copolymer component), more preferably to an extent of at least 90 wt % (based on the total block copolymer content), is a polybutadiene-polyvinylaromatic block copolymer or a mixture of different polybutadiene-polyvinylaromatic block copolymers. This polybutadiene-polyvinylaromatic block copolymer and, respectively, these polybutadiene-polyvinylaromatic block copolymers are polymers comprising polymer blocks predominantly formed from vinylaromatics (A blocks), preferably styrene, and blocks predominantly formed by polymerization of 1,3-butadiene (B blocks). Polybutadiene block copolymers (SBS) are preferred for the purposes of this invention on the basis of their greater stability with respect to external influences such as ozone, for example, by comparison with polyisoprene block copolymers (SIS).

The elastomer mixture preferably comprises at least one polybutadiene-polyvinylaromatic block copolymer consisting of an A block and a B block, known as the diblock copolymer. Diblock copolymers contribute to tack and flow-on of the adhesive. The elastomer mixture further preferably comprises a triblock copolymer or a higher multiblock copolymer having at least two A blocks and at least one B block. As a triblock copolymer, this copolymer may have a linear A-B-A structure. Likewise employable are block copolymers with a radial architecture, and also star-shaped and linear multiblock copolymers. Triblock and multiblock copolymers contribute to cohesion and tensile strength of the adhesive. A plurality of different diblock copolymers may be used. A plurality of triblock and/or multiblock copolymers may be used. The total block copolymer content of the adhesive is in particular at least 40 wt % and at most 60 wt %. Significantly lower fractions of elastomer result in inadequate cohesion, which is manifested in reduced holding power and/or reduced tear resistance during the detachment operation carried out with extensive stretching. Significantly higher fractions of elastomer result in a drop in bond strength. The fraction of diblock copolymers, based on the total block copolymer content, in the adhesive formulation is advantageously between at least 10 wt % and at most 30 wt %. Significantly higher diblock fractions result in inadequate cohesion, which is manifested in reduced holding power and/or reduced tear resistance during the detachment operation carried out with extensive stretching. Significantly lower diblock fractions result in a drop in bond strength. Correspondingly, the fraction of triblock or higher multiblock copolymer in this advantageous embodiment is from 40 wt % to 60 wt %, in relation to the total block copolymer content. Of the triblock or higher multiblock copolymers, the triblock copolymers are particularly preferred.

The weight-average molar mass (measured according to Test I) of the block copolymers is between 50 000 g/mol and 500 000 g/mol, preferably between 75 000 g/mol and 200 000 g/mol. The fraction of vinylaromatic block in the block copolymers may be different from one variety of block copolymer to another in the formulation, but is typically at least 20 wt %, preferably at least 25 wt %, and at most 40 wt %, preferably at most 35 wt %. Too low a polyvinylaromatic fraction results in insufficient physical crosslinking, which is provided by microphase separation in the polybutadiene block copolymers. The physical crosslinking is important for the holding power and the tear resistance. If the polyvinylaromatic fraction is too high, in contrast, the adhesive loses tack.

The A blocks in the block copolymers of the PSAs are preferably polystyrene end blocks. Instead of the preferred polystyrene blocks, other vinylaromatics which can be utilized are polymer blocks based on other aromatic-containing homopolymers and copolymers (preferably C8 to C12 aromatics) having glass transition temperatures of greater than 75° C., such as α-methylstyrene-containing aromatic blocks, for example. Furthermore, identical or different A blocks may also be present. Glass transition temperatures are determined according to Test II.

A blocks in the context of this invention are also referred to as “hard blocks”. B blocks, correspondingly, are also called “soft blocks” or “elastomer blocks”. This reflects the inventive selection of the blocks in accordance with their glass transition temperatures (for A blocks at least 40° C., more particularly at least 60° C., and for B blocks at most −50° C., more particularly at most −80° C.). These figures relate to the pure, unblended block copolymers.

The polybutadiene block copolymers resulting from the A and B blocks may comprise identical or different B blocks in terms more specifically of microstructure (relative ratio of the types of monomer linkage possible for polybutadiene, i.e., 1,4-cis, 1,4-trans, and 1,2-vinyl: the 1,4 fraction (cis+trans) is preferably >75%, very preferably >85%, based on the polybutadiene blocks, and the 1,4-cis fraction is preferably >40%, based on the polybutadiene blocks) and/or of chain length. A high fraction of 1,4 linkage and especially 1,4-cis linkage of the monomer units in the polybutadiene blocks leads to advantageous tension/elongation characteristics, resulting in sufficient stretchability, which is important particularly for the residue-free redetachment by stretching. The 1,2-vinyl units may be in hydrogenated form. Advantageously, the 1,4 units are substantially unhydrogenated.

(b) Tackifier Resin

The adhesive HKB1 further comprises a tackifier resin. Here again, the tackifier resins are special compounds having a low molar mass by comparison with the elastomers, their molecular weight (Test I) M_{w} typically being <5000 g/mol. The molecular weight M_{w} is typically from 500 to 5000 g/mol, preferably from 500 to 2000 g/mol. The at least one tackifier resin has a DACP (according to Test III) of at least about +5° C. and at most about +50° C., preferably at most about +45° C., and also an MMAP (according to Test IV) of at least about +50° C. and at most about +85° C., preferably at most of about +80° C. For tackifier resins selected appropriately, compatibility with the polybutadiene blocks and incompatibility with polyvinylaromatic blocks is anticipated to an extent favorable for the purposes of this information. The tackifier resin has a resin softening temperature (according to Test V) of at least about 90° C., preferably of at least about 110° C., and at most +140° C., preferably of at most +120° C. The at least one tackifier resin used advantageously comprises a hydrocarbon resin.

Polarity which is too high (DACP too low) leads to incipient incompatibility with the vinylaromatic blocks, possibly resulting in a reduction in cohesion and hence in the tensile strength. Polarity which is too low (DACP too high) leads to incompatibility on the part of the tackifier resin with the soft block and hence to a loss of pressure-sensitive adhesiveness.

Aromaticity which is too high (MMAP too low) leads to incipient incompatibility with the vinylaromatic blocks, possibly leading to reduction in cohesion and hence in the tensile strength. Aromaticity which is too low (MMAP too high) leads to incompatibility on the part of the tackifier resin with the soft block and hence to a loss of pressure-sensitive adhesiveness.

The resins are selected preferably from the resin classes of the (partially) hydrogenated aromatically modified C5 resins, the polyterpene resins (prepared from α-pinene, β-pinene, δ-limonene, or mixtures of these starting materials), the partially hydrogenated C9 resins, the (partially) hydrogenated aromatically modified a-pinene resins, the (partially) hydrogenated aromatically modified β-pinene resins, the (partially) hydrogenated aromatically modified δ-limonene resins, and the (partially) hydrogenated aromatically modified dipentene resins. In the context of the aromatic modification, preference is given to styrene. Polyterpene resins are especially preferred.

(c) Optionally Employable Plasticizing Resins

Optionally a plasticizing resin is employable and serves for final fine-tuning of the cohesion/adhesion balance. The resin in question very preferably comprises a plasticizing resin or plasticizing resin mixture with a melting viscosity of at least 25 Pa*s, preferably of at least 50 Pa*s, at 25° C. and 1 Hz, and with a softening temperature of <25° C. The melt viscosity is determined according to Test VI. The plasticizing resin may be a rosin-based plasticizing resin or very preferably a hydrocarbon-based plasticizing resin. The plasticizing resin or plasticizing resin mixture is employed, in relation to the total adhesive formulation, with a fraction of at most 12 wt %, preferably of at most 5 wt %, based on the total adhesive composition. Too high a fraction of plasticizing resin results in a reduction in cohesion, which is manifested in the holding power and in the tensile strength.

In HKB1, however, low-viscosity plasticizers such as mineral oils are also conceivable as a constituent of the PSA layer HKB1 for the purposes of this invention. Their fraction in the overall formula is preferably at most 5 wt %, more preferably at most 3 wt %. It is also possible to do entirely without such plasticizers. A disadvantage of low-viscosity plasticizers is the risk of possible migration into a layer in contact with the adhesive layer HKB1, such as a (foam) carrier layer, for example.

(d) Optional Further Additives

The adhesive HKB1 likewise may be admixed with further additives, especially inhibitors. These include aging inhibitors of primary and secondary types, light stabilizers and UV protectants, and also flame retardants, and additionally fillers, dyes, and pigments. The adhesive may accordingly be given any desired color or may be white, grey, or black.

Typical usage amounts for an additive are up to 1 wt %, based on the total adhesive composition. Fillers can be used at higher quantities, typically in a fraction of up to 5 wt %, based on the total adhesive composition.

Additives which can typically be utilized are as follows:
primary antioxidants such as sterically hindered phenols, for example
secondary antioxidants, such as phosphites or thioethers, for example
processing stabilizers such as C-radical scavengers, for example
flame retardants
light stabilizers such as UV absorbers or sterically hindered amines, for example
dyes and/or pigments (e.g., carbon black)
processing assistants
(nano)fillers such as, for example, silicon dioxide, aluminum oxide, titanium dioxide, or phyllosilicates, and color pigments and dyes (for transparent embodiments which nevertheless have deliberate coloring) and also optical brighteners
endblock reinforcer resins, and
optionally further polymers, preferably elastomeric in nature; elastomers utilizable accordingly include, among others, those based on pure hydrocarbons, as for example polybutadiene, elastomers with substantial chemical saturation such as, for example, saturated ethylene-propylene copolymers, α-olefin copolymers, polyisobutylene, butyl rubber, ethylene-propylene rubber, and also chemically functionalized hydrocarbons such as, for example, halogen-containing, acrylate-containing, and allyl or vinyl ether-containing polyolefins.

The selection of additives is preferably confined to those specified above.

Pressure-Sensitive Adhesive HKA2 and HKB2

Alternatively to HKA1, for bonding on rough/splittable substrates, it is also possible advantageously to use HKA2. In this case, HKB2 can be used advantageously as second adhesive layer. HKA2 offers a good balance between tear strength on the one hand and conformability to a rough substrate on the other. Utilizing HKA2 then makes it possible to have a symmetrical product construction, provided that HKA2 and HKB2 are selected identically in terms of composition.

(a) Elastomer (Block Copolymer)

Employed as elastomer component (block copolymer component) in each case, but independently of one another, preferably to an extent of at least 90 wt % (based on the total block copolymer content), is a polybutadiene-polyvinylaromatic block copolymer or a mixture of different polybutadiene-polyvinylaromatic block copolymers. This polybutadiene-polyvinylaromatic block copolymer and, respectively, these polybutadiene-polyvinylaromatic block copolymers are polymers comprising polymer blocks predominantly formed from vinylaromatics (A blocks), preferably styrene, and blocks predominantly formed by polymerization of 1,3-butadiene (B blocks). Polybutadiene block copolymers (SBS) are preferred for the purposes of this invention on the basis of their greater stability with respect to external influences such as ozone, for example, by comparison with polyisoprene block copolymers (SIS).

The elastomer mixture comprises at least one polybutadiene-polyvinylaromatic block copolymer consisting of an A block and a B block, known as the diblock copolymer. Diblock copolymers contribute to tack and flow-on of the adhesive. The elastomer mixture further comprises a triblock copolymer or a higher multiblock copolymer having at least two A blocks and at least one B block. As a triblock copolymer, this copolymer may have a linear A-B-A structure. Likewise employable are block copolymers with a radial architecture, and also star-shaped and linear multiblock copolymers. Triblock and multiblock copolymers contribute to cohesion and tensile strength of the adhesive. A plurality of different diblock copolymers may be used. A plurality of triblock and/or multiblock copolymers may be used. The total block copolymer content of the adhesive is in particular at least 38 wt % and at most 48 wt %. Significantly lower fractions of elastomer result in inadequate cohesion, which is manifested in reduced holding power and/or reduced tear resistance during the detachment operation carried out with extensive stretching. Significantly higher fractions of elastomer result in a drop in bond strength particularly on nonpolar substrates such as, for example, nonpolar paint. The fraction of diblock copolymers, based on the total block copolymer content, in the adhesive formulation is at least 10 wt % and at most 30 wt %. Significantly higher diblock fractions result in inadequate cohesion, which is manifested in reduced holding power and/or reduced tear resistance during the detachment operation carried out with extensive stretching. Significantly lower diblock fractions result in a drop in bond strength particularly on nonpolar substrates such as, for example, nonpolar paint. Correspondingly, the fraction of triblock or higher multiblock copolymer is from 70 wt % to 90 wt %, in relation to the total block copolymer content. Of the triblock or higher multiblock copolymers, the triblock copolymers are particularly preferred.

The weight-average molar mass (measured according to Test I) of the block copolymers is between 50 000 g/mol and 500 000 g/mol, preferably between 75 000 g/mol and 200 000 g/mol. The fraction of vinylaromatic block in the block copolymers may be different from one variety of block copolymer to another in the formulation, but is typically at least 20 wt %, preferably at least 25 wt %, and at most 40 wt %, preferably at most 35 wt %. Too low a polyvinylaromatic fraction results in insufficient physical crosslinking, which is provided by microphase separation in the polybutadiene block copolymers. The physical crosslinking is important for the holding power and the tear resistance. If the polyvinylaromatic fraction is too high, in contrast, the adhesive loses tack.

The A blocks in the block copolymers of the PSAs are preferably polystyrene end blocks. Instead of the preferred polystyrene blocks, other vinylaromatics which can be utilized are polymer blocks based on other aromatic-containing homopolymers and copolymers (preferably C8 to C12 aromatics) having glass transition temperatures of greater than 75° C., such as α-methylstyrene-containing aromatic blocks, for example. Furthermore, identical or different A blocks may also be present. Glass transition temperatures are determined according to Test II.

A blocks in the context of this invention are also referred to as “hard blocks”. B blocks, correspondingly, are also called “soft blocks” or “elastomer blocks”. This reflects the inventive selection of the blocks in accordance with their glass transition temperatures (for A blocks at least 40° C., more particularly at least 60° C., and for B blocks at most −50° C., more particularly at most −80° C.). These figures relate to the pure, unblended block copolymers.

The polybutadiene block copolymers resulting from the A and B blocks may comprise identical or different B blocks in terms more specifically of microstructure (relative ratio of the types of monomer linkage possible for polybutadiene, i.e., 1,4-cis, 1,4-trans, and 1,2-vinyl: the 1,4 fraction (cis+trans) is preferably >75%, very preferably >85%, based on the polybutadiene blocks, and the 1,4-cis fraction is preferably >40%, based on the polybutadiene blocks) and/or of chain length. A high fraction of 1,4 linkage and especially 1,4-cis linkage of the monomer units in the polybutadiene blocks leads to advantageous tension/elongation characteristics, resulting in sufficient stretchability, which is important particularly for the residue-free redetachment by stretching. The 1,2-vinyl units may be in hydrogenated form. Advantageously, the 1,4 units are substantially unhydrogenated.

(b) Tackifier Resin

The at least one tackifier resin used is in each case, but independently of one another for HKA2 and HKB2, a hydrocarbon resin having a DACP (according to Test III) of at least about +5° C. and at most about +50° C., preferably of at most about +45° C., and also an MMAP (according to Test IV) of at least about +50° C. and at most about +85° C., preferably of at most about +80° C. The tackifier resin has a resin softening temperature (according to Test V) of at least about 90° C. and at most +140° C., preferably of at least about 110° C. and at most +120° C. Tackifier resins are special compounds having a low molar mass by comparison with the elastomers, their molecular weight (Test I) M_{w} typically being <5000 g/mol. The molecular weight M_{w} is typically from 500 to 5000 g/mol, preferably from 500 to 2000 g/mol. For tackifier resins selected appropriately, compatibility with the polybutadiene blocks and incompatibility with polyvinylaromatic blocks is anticipated to an extent favorable for the purposes of this information.

Polarity which is too high (DACP too low) leads to incipient incompatibility with the vinylaromatic blocks, possibly resulting in a reduction in cohesion and hence in the tensile strength. Polarity which is too low (DACP too high) leads to incompatibility on the part of the tackifier resin with the soft block and hence to a loss of pressure-sensitive adhesiveness.

Aromaticity which is too high (MMAP too low) leads to incipient incompatibility with the vinylaromatic blocks, possibly leading to reduction in cohesion and hence in the tensile strength. Aromaticity which is too low (MMAP too high) leads to incompatibility on the part of the tackifier resin with the soft block and hence to a loss of pressure-sensitive adhesiveness.

The resins are selected preferably from the resin classes of the (partially) hydrogenated aromatically modified C5 resins, the polyterpene resins (prepared from α-pinene, β-pinene, δ-limonene, or mixtures of these starting materials), the partially hydrogenated C9 resins, the (partially) hydrogenated aromatically modified a-pinene resins, the (partially) hydrogenated aromatically modified β-pinene resins, the (partially) hydrogenated aromatically modified δ-limonene resins, and the (partially) hydrogenated aromatically modified dipentene resins. In the context of the aromatic modification, preference is given to styrene. Polyterpene resins are especially preferred.

(c) Plasticizing Resins

The plasticizing resin serves for final fine-tuning of the cohesion/adhesion balance. The resin in question in each case, but independently of one another for HKA2 and HKB2, is very preferably a plasticizing resin or plasticizing resin mixture with a melting viscosity of at least 25 Pa*s, preferably of at least 50 Pa*s, at 25° C. and 1 Hz, and with a softening temperature of <25° C. The melt viscosity is determined according to Test VI. The respective plasticizing resin may be a rosin-based plasticizing resin or very preferably a hydrocarbon-based plasticizing resin. The plasticizing resin or plasticizing resin mixture is employed, in relation to the total adhesive formulation, in each case, but independently of one another, with a fraction of 2 wt %, preferably of at least 5 wt % and at most 15 wt %, more preferably at most 12 wt %, based on the total adhesive composition. Too high a fraction of plasticizing resin results in a reduction in cohesion, which is manifested in the holding power and in the tensile strength.

Customary low-viscosity plasticizers such as mineral oils are disadvantageous for the purposes of this invention. Their fraction in the total formula especially for HKA2 is preferably not more than 1 wt %, and very preferably no such plasticizers at all are used. A disadvantage of low-viscosity plasticizers is the risk of grease saturation on absorbent bond substrates such as woodchip wallpaper. When the adhesive strip is redetached, an unwanted visible sign is left at the bond site. Higher fractions (for example, up to 5 wt %) may be used for HKB2.

Optional Further Additives

The respective adhesive may in each case, but independently of one another, be admixed with, as further additives, inhibitors in particular. These include aging inhibitors of primary and secondary types, light stabilizers and UV protectants, and also flame retardants, and additionally fillers, dyes, and pigments. The adhesive may accordingly be given any desired color or may be white, grey, or black.

Typical usage amounts for an additive are up to 1 wt %, based on the total adhesive composition. Particularly advantageous are aging inhibitors which do not leave colored residues on bond substrates.

Fillers can be used at higher quantities, typically in a fraction of up to 5 wt %, based on the total adhesive composition.

Additives which can typically be utilized are as follows:
primary antioxidants such as sterically hindered phenols, for example
secondary antioxidants, such as phosphites or thioethers, for example
processing stabilizers such as C-radical scavengers, for example
flame retardants
light stabilizers such as UV absorbers or sterically hindered amines, for example
dyes and/or pigments (e.g., carbon black)
processing assistants
(nano)fillers such as, for example, silicon dioxide, aluminum oxide, titanium dioxide, or phyllosilicates, and color pigments and dyes (for transparent embodiments which nevertheless have deliberate coloring) and also optical brighteners
endblock reinforcer resins, and
optionally further polymers, preferably elastomeric in nature; elastomers utilizable accordingly include, among others, those based on pure hydrocarbons, as for example polybutadiene, elastomers with substantial chemical saturation such as, for example, saturated ethylene-propylene copolymers, a-olefin copolymers, polyisobutylene, butyl rubber, ethylene-propylene rubber, and also chemically functionalized hydrocarbons such as, for example, halogen-containing, acrylate-containing, and allyl or vinyl ether-containing polyolefins.

The selection of additives is preferably confined to those specified above.

Layer thicknesses of the PSA layers HKA and HKB may independently of one another be at least 20 μm and preferably at most 250 μm, preferably at least 50 μm and very preferably at most 150 μm. The layer thicknesses of the PSA layer HKA and of the PSA layer HKB may be the same or different, and PSA layer HKA may be thicker or thinner than PSA layer HKB.

Foam Carrier

At least one layer of the carrier material is foamed. The foam layer is selected specifically to achieve the object. The aim here is to create a sufficient balance between conformability and holding power. Conformability is important for the adhesive products, in order to create an optimum contact area between adhesive layer and rough substrate (especially woodchip wallpaper). For this purpose, the foam is required to have a specific thickness, density, and compression stress. At the same time, however, the foam must not tear too easily under load, to allow objects to be affixed to the self-adhesive article. The parameters of thickness and density must likewise be selected appropriately for this purpose.

It has now been found that for the at least one foamed layer of the carrier material, a thickness of at least 500 μm and at most 1800 μm, preferably of at least 850 μm and at most 1500 μm, is especially suitable for adhesive strips for bonding on rough substrates with a high holding power. For woodchip wallpaper, typically roughnesses may lie in the region of 500 μm or even above. If the foams are too thin, the conformability to the rough bond substrate is inadequate. The adhesive layer comes only into incomplete contact with the surface of the bonding substrate, resulting in reduced bond strength. If the foam carrier is too thick, then the load, resulting for example from an object being hung from a hook, results in excessive deflection of the bond and possibly even tearing of the foam.

It has emerged, moreover, that a density of at least 30 kg/m³ and at most 120 kg/m³, preferably at least 45 kg/m³ and at most 100 kg/m³, leads to adhesive strips which are particularly suitable for achieving the object. Low densities likewise allow the required conformability. Densities that are too low, however, harbor the risk of the foam carrier tearing under load. Densities that are too high result in inadequate conformability.

Furthermore, for the foam layer of the carrier material, a defined compression stress (compression stress, 50% according to ISO 3386-1), specifically of at least 50 kPa and at most 300 kPa, preferably at least 70 kPa and at most 200 kPa, is important. Systems whose compression stress is too low typically have little resistance to tears. Excessively high compression stress values permit incomplete conformability of the adhesive strip to the rough bonding surface. This is then manifested positively in the holding power.

For the detachment operation, moreover, a tensile strength (according to ISO 1926, testing velocity 500 mm/min) in detachment direction of at least 500 kPa, preferably at least 700 kPa, has proven advantageous. By way of the tensile strength, the foamed layer of the carrier material contributes to the tear resistance of the adhesive strip. If the tensile strength is too low, the adhesive article may tear during detachment carried out by extensive stretching. In that case, a greater requirement would be imposed on the tensile strength of the adhesive layers, thereby restricting the freedom of formulation and complicating the achievement of other technical adhesive properties.

For the foam layer of the carrier material, furthermore, a tensile elongation (according to ISO 1926, testing velocity 500 mm/min) in detachment direction of at least 500% is selected if the compression stress is at least 120 kPa, while the selected tensile elongation is at least 300% if the compression stress is below 120 kPa. A certain minimum stretchability is necessary in order to allow distance sufficiently for the detachment of the adhesive from the substrate.

In connection with the tensile strength and the tensile elongation, reference is made to the detachment direction of the adhesive product. This is important because the mechanical properties of foam layers which are used in the carrier material may typically differ transverse to their production direction and in the direction longitudinally to their production direction. For the adhesive products of the invention it is initially immaterial whether the foam layer is employed in such a way that the detachment direction is parallel to the longitudinal direction of the foam layer production process, or to the transverse direction. What is critical is that the mechanical properties of the foam layer conform to the parameter ranges identified above in accordance with the stresses that occur in the detachment process. If the adhesive product, for example, is produced in such a way that the foam layer in the detachment process is stretched transverse to its production direction, the mechanical properties of the foam layer transverse to the production direction of the foam layer are relevant. If, on the other hand, the adhesive product is produced in such a way that the foam layer in the detachment process is stretched longitudinally to its production direction, then the mechanical properties of the foam layer longitudinally to the production direction of the foam layer are relevant.

Moreover, a modulus of elasticity of at most 7 MPa is advantageous. This mechanical variable describes the force profile in the initial stage of the stretching of a material, and indicates a certain capacity for resistance to its initial deformation. Given that the adhesive strip is to be able to be employed on readily splittable substrates and that in that case nondestructive redetachment is to be possible, the preference is for a low modulus of elasticity.

The foam layer may optionally be “filmed” (provided with a film layer) on one or both sides. Film layers in that case are typically less than 75 μm thick. Preference is given to working without filming. Advantages of the filming are frequently found in the holding power. Conversely, the effect of filming on the force that has to be expended for stretching (stripping force) is negative, this force being higher than if using an unfilmed foam. Too high a stripping force harbors the risk of the sensitive bond substrate being damaged during the detachment process.

A preferred material for the foam layer is polyolefin. Polyethylene-based foams are extremely suitable. The foam layer may have undergone chemical and/or physical pretreatment on one or more of its surfaces, in order for example to improve the anchorage of further layers thereon. Examples of pretreatment options include corona, flaming, vapor deposition, fluorination, and plasma.

The profile of properties of self-adhesive articles of the invention is as follows:

| | | | Value | | Measure- |
|---|---|---|---|---|---|
| | Physical measured | | (or range of | | ment |
| Property | variable | Unit | values) | | method |
| Holding power | Tip-shear withstand | Days | >20 | days | Test VII |
| | time on wallpaper, | | | | |
| | 1.0 kg load | | | | |
| Detachment | Stripping force | N/cm | ≤11 | N/cm | Test VIII |
| behavior | | | | | |

For strippable self-adhesive products, moreover, the resistance to tears is important, enabling an assurance to be given that the adhesive product does not tear during detachment by extensive stretching. A foam carrier itself has a relatively low tensile strength. In order to obtain sufficient resistance to tears for the strippable adhesive products, the adhesive layers as well must make a contribution to the resistance to tears. One variable associated with this is the tensile strength of the individual adhesive layers.

The tensile strength, measured according to Test IX, ought advantageously to be at least 5.0 MPa, preferably at least 8.0 MPa. At least one adhesive layer advantageously has a tensile strength of at least 8.0 MPa, preferably of at least 10.0 MPa. A tensile strength of at least 8.0 MPa is necessary if the adhesive products have a comparatively low layer thickness of the adhesive formulation of the invention (e.g., less than 250 μm). Alternatively or additionally, a further layer may be introduced into the self-adhesive product, this layer providing a higher tensile strength—a carrier material or a further layer of adhesive is an example. The resistance to tears is dependent, moreover, on the stripping force. The higher this force, the higher also the requirements imposed on the tensile strength of the self-adhesive product. Conversely, self-adhesive products with a relatively low stripping force allow tensile strengths which are situated at a relatively low level. Relatively low stripping forces, moreover, permit gentler redetachment from sensitive substrates such as woodchip wallpaper or plaster, thereby making it possible more effectively to prevent destruction during detachment.

The self-adhesive articles of the invention are double-sidedly pressure-sensitive self-adhesive products, and more particularly are sections (adhesive strips) of adhesive tape or of films that have been punched or otherwise cut to size. Adhesive strips may adopt any desired sizing in both dimensions. They typically have a length of at least 5 mm. Lengths may also be 10 mm, 20 mm, 50 mm, 100 mm, or more. Widths are typically at least 2 mm. Widths may also be 5 mm, 10 mm, 20 mm, 50 mm or more. Although self-adhesive articles of the invention can be used advantageously as adhesive strips, there are also diverse possibilities for application on product constructions according to the invention in the form of adhesive assembly tape. With product designs of this kind, the width of the adhesive tape is in that case, for example, likewise 5 mm, 10 mm, 20 mm, 50 mm or above. Adhesive tapes, however, are processed into longer sections, as for example 5 m, 10 m, or even 50 m. These tapes are then made available to the user in a practical, wound form.

The adhesive strips are customarily longer than they are wide, with the stretching for redetachment then being situated advantageously along the longitudinal axis. All angles of the punched diecuts may amount to 90° or may differ from that figure. Also possible are shapes for which the adhesive strip tapers in at least one direction, and in particular runs out to a point. Edges may also be rounded.

Adhesive strips may include grip tab regions, which to the upper side and/or lower side of the adhesive strip are not tacky. This region serves as a grip tab, which is pulled in order to obtain the extensive stretching, especially in the bond plane, and this region is preferably made non-tacky on both sides, therefore, more particularly through the application of layers of metal, plastic or paper, as described above. Alternatively, the grip tab region may be produced by irradiation, powdering, or neutralization of the adhesive. As another alternative, a varnish or a primer may be applied at the locations in question. Moreover, the surface may be altered by chemical treatment such as etching in order to generate nonadhesive zones in each case. A grip-tab film roughness Sₐ of 0.10 to 2.00 μm, preferably of 0.15 to 0.50 μm, ensures an effective bond between film and PSA and may therefore be selected advantageously for this purpose. The roughness in this context is defined according to ISO 25178-2:2012(E) section 4.1.7 (see also Test X).

Self-adhesive articles of the invention are in particular provided on a release liner (preferably siliconized paper or film). The liner may be equipped for one-sided release. In that case advantageously a second ply of a liner is used in order to line the second surface. The liner may also be equipped for double-sided release.

Product thicknesses may be at least 700 μm and at most 2500 μm, preferably at least 900 μm and at most 1800 μm.

Lastly, the present invention also encompasses the use of the adhesive of the invention or of the adhesive tape of the invention for bonding on woodchip wallpaper, especially coated woodchip wallpaper, or on plaster, especially on coated plaster. The adhesive and adhesive tape of the present invention are also particularly suitable for bonding on other rough and/or easily splittable surfaces such as wood, wainscoting, wood veneers, textured wallpapers, and panels or wall boards.

Possible further applications of such self-adhesive tapes are found in DE 42 33 872 A1, DE 195 11 288 A1, U.S. Pat. No. 5,507,464 A, U.S. Pat. No. 5,672,402 A, and WO 94/21157 A1, specific embodiments are found for example in DE 44 28 587 A1, DE 44 31 914 A1, WO 97/07172 A1, DE 296 23 112 U1, WO 98/03601 A1, and DE 196 49 636 A1, DE 198 13 081 A1, DE 197 23 177 A1, DE 297 23 198 A1, DE 297 23 614 U1, DE 197 56 084 A1, DE 197 56 816 A1, DE 198 42 864 A1, DE 198 42 865 A1, WO 99/31193 A1, WO 99/37729 A1, and WO 99/63018 A1.

Test Methods

Test I—Molecular Weight, GPC

The weight-average molecular weight Mw was determined by means of gel permeation chromatography (GPC). The eluent used was THF. The measurement was made at 23° C. The pre-column used was PSS-SDV, 5μ, 10³ Å, ID 8.0 mm×50 mm. Separation took place using the columns PSS-SDV, 5μ, 10³ and also 10⁴ and 10⁶ each with ID 8.0 mm×300 mm. The sample concentration was 4 g/l, the flow rate 1.0 ml per minute. Measurement was made against PS standards. (μ=μm; 1 Å=10⁻¹⁰ m).

GPC is also an appropriate measurement method for determining the diblock fraction, if manufacturer details for a block copolymer are not available. For the block copolymers which can be used for the purposes of this invention and are produced by living anionic polymerization, the molar mass distributions are typically narrow enough to allow polymer modes, assignable to triblock copolymers on the one hand and diblock copolymers on the other, to appear with sufficient resolution from one another in the elugram. The diblock fraction can then be quantified as the integral of the corresponding molar mass signal, relative to the sum total of the integrals of the molar mass signals of the diblock mode and of the other block copolymer modes (triblock mode or mode of a higher block copolymer).

Test II—DSC

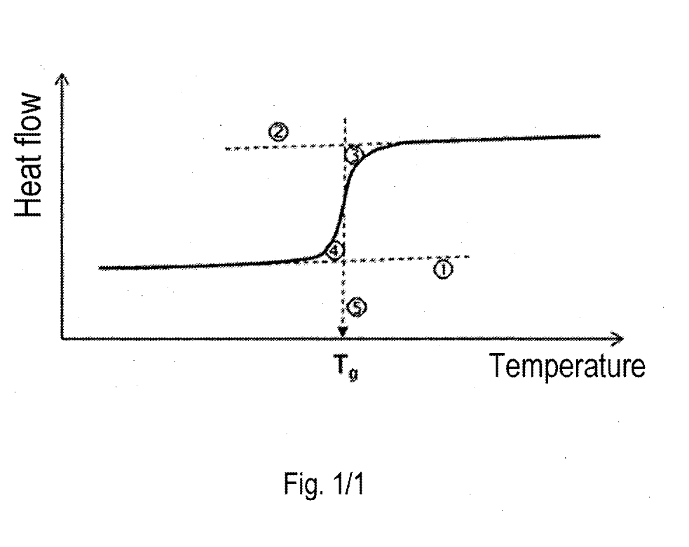

The glass transition temperature of polymer blocks in block copolymers was determined by means of dynamic scanning calorimetry (DSC). For this test, around 5 mg of the untreated block copolymer samples were weighed out into an aluminum crucible (volume 25 μl) and closed with a perforated lid. For the measurement, a DSC 204 F1 from Netzsch was used and was operated under nitrogen for inertization. The sample was first cooled to −150° C., heated to +150° C. at a heating rate of 10 K/min, and cooled again to −150° C. The subsequent second heating curve was run again at 10 K/min, and the change in the heat capacity was recorded. Glass transitions are recognized as steps in the thermogram. The glass transition temperature is evaluated as follows (in this regard, see FIG. 1). A tangent is applied in each case to the baseline of the thermogram before 1 and after 2 of the step. In the region of the step, a line 3 of best fit is placed parallel to the ordinate in such a way that the two tangents intersect, specifically such as to form two areas 4 and 5 (between the respective tangent, the line of best fit, and the measurement plot) of equal content. The point of intersection of the lines of best fit positioned accordingly and the measurement plot gives the glass transition temperature.

Test III—DACP

The DACP is the diacetone cloud point and for the purposes of the present invention is determined as follows: 5.0 g of test substance (the tackifier resin specimen under investigation) are weighed out into a dry sample glass and admixed with 5.0 g of xylene (isomer mixture, CAS [1330-20-7], 98.5%, Sigma-Aldrich #320579 or comparable). The test substance is dissolved at 130° C. and then cooled to 80° C. Any xylene that has escaped is made up with further xylene, to restore 5.0 g of xylene. Then 5.0 g of diacetone alcohol (4-hydroxy-4-methyl-2-pentanone, CAS [123-42-2], 99%, Aldrich #H41544 or comparable) are added. The sample glass is shaken until the test substance has completely dissolved. For this purpose, the solution is heated to 100° C. The sample glass containing the resin solution is then introduced into a Chemotronic Cool cloud point instrument from Novomatics, in which it is heated to 110° C. It is cooled at a cooling rate of 1.0 K/min. The cloud point is detected optically. A recording is made for this purpose of the temperature at which the clouding of the solution amounts to 70%. The result is reported in ° C. The lower the DACP, the higher the polarity of the test substance.

Regarding the determination of DACP, reference is made to C. Donker, PSTC Annual Technical Seminar, Proceedings, pp. 149-164, May 2001.

Test IV—MMAP

MMAP is the mixed methylcyclohexane-aniline cloud point, determined using a modified ASTM D 611 method. For the purposes of the present invention, the MMAP is determined by weighing out 5.0 g of test substance, i.e., the tackifier resin specimen under investigation, into a dry sample glass and adding 10 ml of dry aniline (CAS [62-53-3], ≥99.5%, Sigma-Aldrich #51788 or comparable) and 5 ml of dry methylcyclohexane (CAS [108-87-2], 99%, Sigma-Aldrich #300306 or comparable). The sample glass is shaken until the test substance has fully dissolved. For this purpose, the solution is heated to 100° C. The sample glass containing the resin solution is then introduced into a Chemotronic Cool cloud point instrument from Novomatics, in which it is heated to 110° C. It is cooled at a cooling rate of 1.0 K/min. The cloud point is detected optically. A recording is made for this purpose of the temperature at which the clouding of the solution amounts to 70%. The result is reported in ° C. The lower the MMAP, the higher the aromaticity of the test substance.

Regarding the determination of MMAP, reference is made to C. Donker, PSTC Annual Technical Seminar, Proceedings, pp. 149-164, May 2001.

Test V—Resin Softening Temperature

The tackifier resin softening temperature is carried out in accordance with the relevant methodology, which is known as Ring & Ball and is standardized according to ASTM E28.

Test VI—Melt Viscosity of Plasticizing Resins

To determine the melt viscosity of the plasticizing resins, a shear stress sweep was carried out in rotation in a shear stress-regulated DSR 200 N rheometer from Rheometrics Scientific. A cone/plate measuring system with a diameter of 25 mm (cone angle 0.1002 rad) was employed; the measuring head was air-mounted and was suitable for standard force measurements. The gap was 0.053 mm and the measuring temperature was 25° C. The frequency was varied from 0.002 Hz to 200 Hz and the melt viscosity at 1 Hz was recorded.

Test VII—Tip-Shear Test

To determine the tip-shear resistance, the adhesive film 750 μm thick under test, or the carrier-containing test specimen with dimensions of 20 mm×50 mm, provided at one end on both sides with a non-tacky grip tab region (obtained by laminating on a biaxially oriented polyester film 25 μm thick with dimensions of 20 mm×13 mm), is first adhered to a substrate panel (pressing time=5 sec) furnished with woodchip wallpaper (Erfurt 52, coated (lambswool roller) with Alpine White). Bonding to the reverse side of the adhesive strip takes place centrally onto a baseplate of steel with dimensions of 40 mm×20 mm×3 mm (length×width×thickness). A steel pin 10 cm long, sitting vertically on the plate face, is fitted onto the baseplate. The specimens obtained are compressed with a force of 100 N and left in the unloaded state for 5 minutes. Following application of the selected tip-shear load, by suspension of a weight (10 N for 20 mm lever arm), a determination is made of the time before the bond fails (i.e., tip-shear withstand time). The test conditions are 23° C. and a relative humidity of 50%. For many applications, the higher the tip-shear withstand time, the better. If 20 days are reached, the test is discontinued and the result is recorded as >20 days.

Test VIII—Stripping Force

For determining the detachment force (stripping force), an adhesive product specimen with dimensions of 50 mm*20 mm (length*width), with a non-tacky grip tab region at the upper end, is adhered between two steel plates (arranged congruently to one another) with dimensions of 60 mm×30 mm, centrally. The specimens thus obtained are pressed at a force of 500 N for 5 sec and thereafter left in the unloaded state for 5 min. The bonds are stored at 23° C. and 50% relative humidity for 24 h. The adhesive sheet strip is extracted with a tensile speed of 1000 mm/min parallel to the bond plane and without contact (for this purpose, in a region free of adhesive sheet, a spacer corresponding to the thickness of the adhesive sheet under investigation is inserted between the steel plates) with respect to the edge regions of the two steel plates. During this procedure, the required detachment force in N is measured. The value reported is the maximum stripping force in N/cm.

Test IX—Tensile Strength

Adhesive specimens are pressed to give layers having a thickness of 750 μm. From these layers, test specimens in dumbbell form (5A test rod according to DIN EN ISO 527) are punched out. These specimens are equilibrated at 23° C. and 50% relative humidity. Using the two endpieces, a test specimen is clamped into a tensile testing machine. The test specimen is stretched at a rate of 1000 mm/min, during which the force is recorded. The tensile strength is the force recorded during elongation at break, based on the cross-sectional area of the specimen (web width x layer thickness). It is reported in MPa.

Test X—Roughness

The surface roughness of the grip tab layer was determined using a Contour GT® 3D Optical Microscope white light interferometer from Bruker. The basis for the test was ISO 25178-602. The instrument was operated in vertical scanning (VSI) mode. A 50× objective lens and a 1× field lens were utilized, resulting in a fifty-fold magnification. The viewing region was 317 μm×238 μm. This is also the area referenced by the evaluated surface roughness Sₐ. From the height profile recorded optically, the surface roughness was obtained from the raw data in accordance with ISO 25178-2:2012 (E) section 4.1.7, as the average of the 3D profile, Sₐ. Sₐ is the arithmetic mean of the amounts of the height values z of all points measured within the x,y plane of the viewing region. Three measurements were conducted in each case, and the mean of the individual measurements was reported in nm. In both the x and the y directions, the distance between the measured points was 0.5 μm.

The present invention relates in particular to the following embodiments:

According to a first embodiment, the invention relates to a self-adhesive article comprising

(i) at least one carrier material which comprises at least one foamed layer having a first surface A and a second surface B,

wherein the at least one foamed layer of the carrier material has
a thickness of at least 500 μm, preferably at least 850 μm, and at most 1800 μm, preferably at most 1500 μm,
a density of at least 30 kg/m³, preferably at least 45 kg/m³, and at most 120 kg/m³, preferably at most 100 kg/m³,
a tensile strength in detachment direction of at least 500 kPa, preferably at least 700 kPa,
a tensile elongation in detachment direction of at least 300%, preferably at least 500%, and
a compression stress of at least 50 kPa, preferably at least 70 kPa, and at most 300 kPa, preferably at most 200 kPa,

(ii) a pressure-sensitive adhesive layer HKA which is assigned to the surface A,

(iii) a pressure-sensitive adhesive layer HKB which is assigned to the surface B,

(iv) optionally one or more further layers,

characterized in that the pressure-sensitive adhesive layers HKA and HKB are selected from a group of pressure-sensitive adhesive layer combinations consisting of pressure-sensitive adhesive layer combination 1 and pressure-sensitive adhesive layer combination 2,

wherein, for pressure-sensitive adhesive layer combination 1, pressure-sensitive adhesive layer HKA is a pressure-sensitive adhesive layer HKA1 which comprises

i. at least one elastomer component of the type of polybutadiene-polyvinylaromatic block copolymer having a fraction in relation to the total adhesive of 42 wt % to 55 wt % and a diblock fraction in relation to the total block copolymer content of 32 wt % to 55 wt %, preferably to 50 wt %,

ii. at least one tackifier resin which is a hydrocarbon resin having a DACP of at least +5° C. and at most +50° C. and an MMAP of at least +50° C. and at most +85° C.,

iii. optionally at least one plasticizing resin having a fraction of 0 wt % to 15 wt %, based on the total adhesive,

iv. optionally further additives

and wherein pressure-sensitive adhesive layer HKB is a pressure-sensitive adhesive layer HKB1 which has a tensile strength of at least 9 MPa, preferably of at least 11 MPa, and wherein, for pressure-sensitive adhesive layer combination 2, pressure-sensitive adhesive layer HKA is a pressure-sensitive adhesive layer HKA2 and pressure-sensitive adhesive layer HKB is a pressure-sensitive adhesive layer HKB2, which each, but independently of one another, comprise

v. at least one elastomer component of the type of a butadiene block copolymer having a fraction in relation to the total adhesive of 38 wt % to 48 wt % and a diblock fraction in relation to the total block copolymer content of 10 wt % to 30 wt %,

vi. at least one tackifier resin which is a hydrocarbon resin having a DACP of at least +5° C. and at most +50° C. and an MMAP of at least +50° C. and at most +85° C.,

vii. at least one plasticizing resin having a fraction of 2 wt % to 15 wt %, based on the total adhesive,

viii. optionally further additives.

According to a second embodiment, the invention relates to a self-adhesive article according to embodiment 1, characterized in that

the pressure-sensitive adhesive layer HKB1 comprises

a) at least one elastomer component of the type of a polybutadiene-polyvinylaromatic block copolymer having a fraction in relation to the total adhesive of 40 wt % to 60 wt % and a diblock fraction in relation to the total block copolymer content of 10 wt % to 30 wt %,

b) at least one tackifier resin which is a hydrocarbon resin having a DACP of at least +5° C. and at most +50° C. and an MMAP of at least +50° C. and at most +85° C.,

c) optionally at least one plasticizing resin having a fraction of 0 wt % to 12 wt %, based on the total adhesive,

d) optionally further additives.

According to a third embodiment, the invention relates to a self-adhesive article according to embodiment 1 or 2, characterized in that

at least one of the elastomer components consists to an extent of at least 90 wt %, based on the total block copolymer content, of at least one polybutadiene block copolymer, wherein the at least one polybutadiene block copolymer comprises polymer blocks predominantly formed by polymerization of vinylaromatics (A blocks), preferably styrene, and blocks predominantly formed by polymerization of 1,3-butadiene (B blocks).

According to a fourth embodiment, the invention relates to a self-adhesive article according to any of embodiments 1 to 3, characterized in that at least one of the tackifier resins is a hydrocarbon resin having a DACP of at most +45° C.

According to a fifth embodiment, the invention relates to a self-adhesive article according to any of embodiments 1 to 4, characterized in that at least one of the tackifier resins is a hydrocarbon resin having an MMAP of at most +80° C.

According to a sixth embodiment, the invention relates to a self-adhesive article according to any of embodiments 1 to 5, characterized in that at least one of the tackifier resins is a hydrocarbon resin having a resin softening temperature of at least +90° C., preferably at least +110° C., and at most +140° C., preferably at most +120° C.

According to a seventh embodiment, the invention relates to a self-adhesive article according to any of embodiments 1 to 6, characterized in that the adhesive comprises at least 5 wt % and at most 15 wt %, preferably at most 12 wt %, of plasticizing resin having a melt viscosity of at least 25 Pa s, based in each case on the total adhesive.

According to an eighth embodiment, the invention relates to a self-adhesive article according to any of embodiments 1 to 7, characterized in that the adhesive comprises at most 1 wt %, preferably 0 wt %, based on the total adhesive, of low-viscosity plasticizers having a viscosity of below 25 Pa s.

According to a ninth embodiment, the invention relates to a self-adhesive article according to any of embodiments 1 to 8, characterized in that it is strippable.

According a tenth embodiment, the invention relates to a self-adhesive article according to any of embodiments 1 to 9, characterized in that it is an adhesive strip.

According to an eleventh embodiment, the invention relates to the use of a self-adhesive article according to any of embodiments 1 to 10 for bonding on woodchip wallpaper, especially coated woodchip wallpaper, textured wallpapers, wood, panels, wall boards, wainscoting, wood veneers, or on plaster, especially coated plaster.

### EXAMPLES

Adhesives

All of the kneading compounds were produced in a heatable double-sigma kneading apparatus from Aachener Maschinenbau Küpper, model III-P1. The jacket of the kneading apparatus was heated by means of a thermal oil heating bath from Lauda. The bath temperature in this case was set at 190° C. Throughout the kneading operation, there was a protective gas atmosphere of CO2. The kneading apparatus was operated at 50 rpm.

First of all, the elastomers were weighed out, together with the solid aging inhibitor Irganox 1010, and introduced into the kneading apparatus. After that, about 10% of the amount of solid resin was added and kneading took place for 15 minutes. Subsequently, at intervals of 10 minutes, a third of the remaining amount of tackifier resin in each case, and also, finally, plasticizing resin, was added and incorporated.

On conclusion of the kneading operation, the kneading compounds were taken from the kneading apparatus and left to cool to room temperature.

After cooling, the compositions were positioned between two plies of siliconized release paper and pressed with a hot press from Lauffer GmbH & CO KG, model RLKV 25, at 130° C. to give hand specimens with a layer thickness of 150 μm or 750 μm (depending on the test to be conducted).

Raw Materials Used

| Raw materials for | | | | |
|---|---|---|---|---|
| adhesive | | Type | Manufacturer | Characterization |
| Elastomers | Kraton D1102 | Polystyrene- | Kraton | Triblock |
| | AS | polybutadiene | Polymers | copolymer with |
| | | block copolymer | | 17% * diblock |
| | Kraton D1118 | Polystyrene- | Kraton | Triblock |
| | ES | polybutadiene | Polymers | copolymer with |
| | | block copolymer | | 78% * diblock |
| Tackifier resins | Dercolyte A115 | α-Pinene resin | DRT | |
| | Piccolyte A115 | α-Pinene resin | Pinova | |
| Plasticizing resins | Wingtack 10 | C5 resin | Cray Valley | |
| Aging inhibitors | Irganox 1010 | Sterically hindered | BASF | |
| | | phenol | | |

*) cf. Kraton product information “The Global Connection for Polymer and Compound Solutions - Product and Application Guide” (KPP/TPG/2011) from 2011.

| | | | | Tensile | Tensile | Compression |
|---|---|---|---|---|---|---|
| | | Thickness | Density | strength | elongation | stress |
| Foam S1 | Alveo TL 0700.8 | 800 μm | 143 kg/m³ | 1900 kPa | 470% | 350 kPa |
| (comparative) | | | | (transverse) | (transverse) | |
| Foam S2 | Alveo TL 1501 | 1000 μm | 67 kg/m³ | 770 kPa | 370% | 140 kPa |
| | | | | (transverse) | (transverse) | |
| Foam S3 | Alveo TL1000.9 | 900 μm | 95 kg/m³ | 1100 kPa | 400% | 190 kPa |
| | | | | (transverse) | (transverse) | |
| Foam S4 | Alveo TA 1001 | 1000 μm | 95 kg/m³ | 830 kPa | 240% | 190 kPa |
| (comparative) | | | | (transverse) | (transverse) | |
| Foam S5 | Alveo TEE 2001 | 1000 μm | 47 kg/m³ | 550 kPa | 309% | 106 kPa |
| | | | | (transverse) | (transverse) | |

(Manufacturer details)

The comparison foam S1 has a compression hardness and density which are too high for the purposes of this invention. The comparative foam S4 has a tensile elongation in detachment direction that is too low for the purposes of this invention.

Pressure-Sensitive Adhesive H1 (PSA Type HKA1):

| | | | |
|---|---|---|---|
| Elastomer | Kraton D1102 AS | Polystyrene-polybutadiene | 21.5 wt % |
| | | block copolymer | |
| | Kraton D1118 ES | Polystyrene-polybutadiene | 28.0 wt % |
| | | block copolymer | |
| Tackifying | Dercolyte A115 | Alpha-pinene resin | 45.0 wt % |
| resin | | | |
| Plasticizing | Wingtack 10 | Aliphatic hydrocarbon resin | 5.0 wt % |
| resin | | | |
| Further | Irganox 1010 | Antioxidant | 0.5 wt % |
| constituents | | | |

Total elastomer content 49.5 wt %; diblock fraction 51.5 wt %; plasticizing resin fraction 5.0 wt %.

Pressure-Sensitive Adhesive H2 (PSA Type HKA1):

| | | | |
|---|---|---|---|
| Elastomer | Kraton D1102 AS | Polystyrene-polybutadiene | 27.5 wt % |
| | | block copolymer | |
| | Kraton D1118 ES | Polystyrene-polybutadiene | 16.5 wt % |
| | | block copolymer | |
| Tackifying | Piccolyte A115 | Alpha-pinene resin | 46.0 wt % |
| resin | | | |
| Plasticizing | Wingtack 10 | Aliphatic hydrocarbon | 9.5 wt % |
| resin | | resin | |
| Further | Irganox 1010 | Antioxidant | 0.50 wt % |
| constituents | | | |

Total elastomer content 44.0 wt %; diblock fraction 44.1 wt %; plasticizing resin fraction 9.5 wt %.

Pressure-Sensitive Adhesive H3 (PSA Type HKB1):

| | | | |
|---|---|---|---|
| Elastomer | Kraton D1102 AS | Polystyrene-polybutadiene | 42.0 wt % |
| | | block copolymer | |
| | Kraton D1118 ES | Polystyrene-polybutadiene | 10.0 wt % |
| | | block copolymer | |
| Tackifier | Dercolyte A115 | Alpha-pinene resin | 43.5 wt % |
| resin | | | |
| Plasticizing | Wingtack 10 | Aliphatic hydrocarbon | 4.0 wt % |
| resin | | resin | |
| Further | Aging inhibitor | Antioxidant | 0.50 wt % |
| constituents | | | |

Total elastomer content 52.0 wt %; diblock fraction 28.7 wt %; plasticizing resin fraction 4.0 wt %.

Tensile strength 12.7 MPa.

Pressure-Sensitive Adhesive H4 (PSA Type HKA2 and/or HKB2)

| | | | |
|---|---|---|---|
| Elastomer | Kraton D1102 AS | Polystyrene-polybutadiene | 45.0 wt % |
| | | block copolymer | |
| Tackifier | Piccolyte A115 | Alpha-pinene resin | 44.5 wt % |
| resin | | | |
| Plasticizing | Wingtack 10 | Aliphatic hydrocarbon | 10.0 wt % |
| resin | | resin | |
| Further | Irganox 1010 | Antioxidant | 0.50 wt % |
| constituents | | | |

Total elastomer content 45.0 wt %; diblock fraction 17.0 wt %; plasticizing resin fraction 10.0 wt %.

Production of Adhesive Products

The foam carriers and adhesives (in a thickness of 150 μm) are cut to a manageable size and laminated directly onto one another by hand, using a pressing roller. Here it must be ensured that the machine direction of the foam coincides with the machine direction of the adhesive. The specimens are subsequently stored for 2 weeks at 23° C. and 50% relative humidity in order to ensure effective anchorage of the adhesive layers on the foam carrier. Test specimens are punched out (according to the test method), e.g., strips with a length of 50 mm and a width of 20 mm, transversely to the machine direction (cross direction).

Testing of Adhesive Products

| | Holding power | Stripping |
|---|---|---|
| | 1.0 kg | force |
| Self-adhesive article A | | |
| H2/S5/H3 | >20 days | 8 N/cm |
| H1/S5/H3 | >20 days | 10 N/cm |
| Self-adhesive article B | | |
| H4/S3/H4 | >20 days | 10 N/cm |
| H4/S2/H4 | >20 days | 10 N/cm |
| Comparative | | |
| H1/S4/H3 | >20 days | 12 N/cm |
| H3/S1/H3 | >20 days | 15 N/cm |
| H4/S4/H4 | >20 days | 13 N/cm |
| H4/S1/H4 | >20 days | 15 N/cm |
| H1/S1/H3 | >20 days | 14 N/cm |
| H3/S2/H3 | >20 days | 13 N/cm |

1. A self-adhesive article comprising
(i) at least one carrier material which comprises at least one foamed layer having a first surface A and a second surface B,
wherein the at least one foamed layer of the carrier material has
a thickness of at least 500 μm and at most 1800 μm
a density of at least 30 kg/m³and at most 120 kg/m³,
a tensile strength in detachment direction of at least 500 kPa, and
a tensile elongation in detachment direction of at least 300%, and
a compression stress of at least 50 kPa and at most 300 kPa,
(ii) a pressure-sensitive adhesive layer HKA which is assigned to the surface A,
(iii) a pressure-sensitive adhesive layer HKB which is assigned to the surface B,
(iv) optionally one or more further layers,
wherein the pressure-sensitive adhesive layers HKA and HKB form a pressure-sensitive adhesive layer combination 1, wherein, for pressure-sensitive adhesive layer combination 1, pressure-sensitive adhesive layer HKA is a pressure-sensitive adhesive layer HKA1 which comprises
i. at least one elastomer component of the type of a polybutadiene-polyvinylaromatic block copolymer having a fraction in relation to the total adhesive of 42 wt % to 55 wt % and a diblock fraction in relation to the total block copolymer content of 32 wt % to 55 wt %,
ii. at least one tackifier resin which is a hydrocarbon resin having a DACP of at least +5° C. and at most +50° C. and an MMAP of at least +50° C. and at most +85° C.,
iii. optionally at least one plasticizing resin having a fraction of 0 wt % to 15 wt %, based on the total adhesive,
iv. optionally further additives
and wherein pressure-sensitive adhesive layer HKB is a pressure-sensitive adhesive layer HKB1 which has
a tensile strength of at least 9 MPa.

2. A self-adhesive article comprising
(i) at least one carrier material which comprises at least one foamed layer having a first surface A and a second surface B,
wherein the at least one foamed layer of the carrier material has
a thickness of at least 500 μm, and at most 1800 μm,
a density of at least 30 kg/m³ and at most 120 kg/m³
a tensile strength in detachment direction of at least 500 kPa,
a tensile elongation in detachment direction of at least 300%, and
a compression stress of at least 50 kPa and at most 300 kPa,
(ii) a pressure-sensitive adhesive layer HKA which is assigned to the surface A,
(iii) a pressure-sensitive adhesive layer HKB which is assigned to the surface B,
(iv) optionally one or more further layers,
wherein the pressure-sensitive adhesive layers HKA and HKB form a pressure-sensitive adhesive layer combination 2, wherein, for pressure-sensitive adhesive layer combination 2, pressure-sensitive adhesive layer HKA is a pressure-sensitive adhesive layer HKA2 and pressure-sensitive adhesive layer HKB is a pressure-sensitive adhesive layer HKB2, which each, but independently of one another, comprise
v. at least one elastomer component of the type of a butadiene block copolymer having a fraction in relation to the total adhesive of 38 wt % to 48 wt % and a diblock fraction in relation to the total block copolymer content of 10 wt % to 30 wt %,
vi. at least one tackifier resin which is a hydrocarbon resin having a DACP of at least +5° C. and at most +50° C. and an MMAP of at least +50° C. and at most +85° C.,
vii. at least one plasticizing resin having a fraction of 2 wt % to 15 wt %, based on the total adhesive,
viii. optionally further additives.

3. The self-adhesive article as claimed in claim 1, wherein
a) the pressure-sensitive adhesive layer HKB1 comprises
a) at least one elastomer component of the type of a polybutadiene-polyvinylaromatic block copolymer having a fraction in relation to the total adhesive of 40 wt % to 60 wt % and a diblock fraction in relation to the total block copolymer content of 10 wt % to 30 wt %,
b) at least one tackifier resin which is a hydrocarbon resin having a DACP of at least +5° C. and at most +50° C. and an MMAP of at least +50° C. and at most +85° C.,
c) optionally at least one plasticizing resin having a fraction of 0 wt % to 12 wt %, based on the total adhesive,
d) optionally further additives.

4. The self-adhesive article as claimed in claim 1, wherein at least one of the elastomer components consists to an extent of at least 90 wt %, based on the total block copolymer content, of at least one polybutadiene block copolymer, wherein the at least one polybutadiene block copolymer comprises polymer blocks predominantly formed by polymerization of vinylaromatics (A blocks) and blocks predominantly formed by polymerization of 1,3-butadiene (B blocks).

5. The self-adhesive article as claimed in claim 1, wherein at least one of the tackifier resins is a hydrocarbon resin having a DACP of at most +45° C.

6. The self-adhesive article as claimed in claim 1, wherein at least one of the tackifier resins is a hydrocarbon resin having an MMAP of at most +80° C.

7. The self-adhesive article as claimed in claim 1, wherein at least one of the tackifier resins is a hydrocarbon resin having a resin softening temperature of at least +90° C. and at most +140° C.

8. The self-adhesive article as claimed in claim 1, wherein the adhesive comprises at least 5 wt % and at most 15 wt % of plasticizing resin, based in each case on the total adhesive.

9. The self-adhesive article as claimed in claim 8, wherein the plasticizing resin has a melt viscosity of at least 25 Pa s.

10. The self-adhesive article as claimed in claim 1, wherein the adhesive comprises at most 1 wt % based on the total adhesive, of low-viscosity plasticizers having a melting viscosity of below 25 Pa s.

11. The self-adhesive article as claimed in claim 1, wherein it is strippable.

12. The self-adhesive article as claimed in claim 1, wherein it is an adhesive strip.

13. A method for bonding on coated woodchip wallpaper, textured wallpapers, wood, panels, wall boards, wainscoting, wood veneers, or on plaster, wherein said bonding is carried out with the self-adhesive article of claim 1.
